(19) United States
(12) Patent Application Publication
(10) Pub. No.: US 2026/0071049 A1
(43) Pub. Date: Mar. 12, 2026

(54) RUBBER COMPOSITION AND PNEUMATIC TIRE

(71) Applicant: Toyo Tire Corporation, Itami-shi (JP)

(72) Inventor: Yosuke Nakaji, Itami-shi (JP)

(73) Assignee: Toyo Tire Corporation, Itami-shi (JP)

(21) Appl. No.: 19/306,080

(22) Filed: Aug. 21, 2025

(30) Foreign Application Priority Data
Sep. 10, 2024 (JP) 2024-155427

(51) Int. Cl. C08K 5/103; B60C 1/00; C08L 9/06

(52) U.S. Cl. CPC C08K 5/103; B60C 1/00; C08L 9/06; C08L 2207/322

(57) ABSTRACT

A rubber composition comprising a diene-based rubber, an aroma oil and a dehydrated castor oil, wherein 0.1≤X/Y≤10 is established when the blending amount of the aroma oil is X and the blending amount of the dehydrated castor oil is Y. It is preferred that the content of the dehydrated castor oil is 1 to 20 parts by mass when the total amount of the diene-based rubber is 100 parts by mass. It is preferred that the content of the aroma oil is 5 to 40 parts by mass when the total amount of the diene-based rubber is 100 parts by mass.

### BACKGROUND OF THE INVENTION

### Field of the Invention

The present invention relates to a rubber composition and a pneumatic tire.

### Description of the Related Art

Conventionally, it has been common to incorporate aroma oil (mineral oil) as a plasticizer into a rubber composition for a pneumatic tire. However, in recent years, there has been an increasing demand for reducing consumption of aroma oil, which is a petroleum-derived resource, toward a social construction conscious of SDGs, and it is desired to use an oil derived from a plant when a pneumatic tire is manufactured.

Patent Document 1 below describes a vulcanizable rubber composition comprising: a solution-polymerized styrene-butadiene rubber 80 phr to 100 phr having a glass-transition temperature which is in the range of −50° C. to −85° C.; a silica 100 phr to 140 phr; and a plasticizer composition comprising a hydrocarbon resin 15 phr to 40 phr and an oil 5 phr to 25 phr, wherein the sum of the amount of said hydrocarbon resin and the amount of said oil is in the range of 35 phr to 50 phr.

Further, Patent Document 2 below describes a rubber composition for a tire tread, which is obtained by blending, with respect to 100 parts by weight of a natural rubber and/or a diene-based synthetic rubber, 40 to 100 parts by weight of carbon black having a 90 to 220 m²/g cetyltriammonium bromide adsorption specific surface area (CTAB) and a 90 to 140 ml/100 g property value of 24M4DBP oil absorption, and 0.1 to 20 parts by weight of an organic unsaturated fatty acid containing 2 or more carbon-carbon double bonds in a molecule containing 10% by weight or more of a conjugated dienic acid containing at least one set of 2 carbon-carbon double bonds in a molecule in a conjugated relation.

### PRIOR ART DOCUMENT

### Patent Document

Patent Document 1: JP-A-2021-21064
Patent Document 2: JP-B-3200067

### SUMMARY OF THE INVENTION

In the technique described in Patent Document 1 described above, sunflower oil, soybean oil and canola oil as oil derived from a plant are used, but when used in pneumatic tire applications, significant compounding adjustments were required to improve tire characteristics, which had room for further improvement.

Incidentally, in the technique described in Patent Document 2 described above, a rubber composition is used in which a dehydrated castor oil fatty acid having a carboxyl group and not having a triglyceride skeleton is blended as an organic unsaturated fatty acid, particularly in order to improve abrasion resistance, when used in a pneumatic tire application.

In view of the above circumstances, it is an object of the present invention to provide a rubber composition using an oil derived from a plant, which becomes a raw material of a vulcanized rubber capable of reducing rolling resistance when used in a pneumatic tire application.

The above object can be achieved by the present invention as described below. Specifically, the present invention relates to a rubber composition (1) containing a diene-based rubber, an aroma oil and a dehydrated castor oil, wherein 0.1≤X/Y≤10 is established when the blending amount of the aroma oil is X and the blending amount of the dehydrated castor oil is Y.

The rubber composition (1) is preferably a rubber composition (2) in which the content of the dehydrated castor oil is 1 to 20 parts by mass when the total amount of the diene-based rubber is 100 parts by mass.

The rubber composition (1) or (2) is preferably a rubber composition (3) in which the content of the aroma oil is 5 to 40 parts by mass when the total amount of the diene-based rubber is 100 parts by mass.

The rubber composition any one of (1) to (3) is preferably a rubber composition (4) further containing silica.

The present invention also relates to a pneumatic tire containing a vulcanized rubber of the rubber composition any one of (1) to (4).

The rubber composition according to the present invention contains dehydrated castor oil as an oil derived from a plant. The dehydrated castor oil contains, as a main component, triglycerides in which ricinoleic acid which are fatty acids and glycerin are ester-linked. In other words, the dehydrated castor oil fatty acid having a carboxyl group and not having triglyceride skeleton and the dehydrated castor oil are completely different from each other, and as far as the present inventor is aware, there is no example of a case in which a dehydrated castor oil is blended in a rubber composition used particularly for a pneumatic tire application.

In the dehydrated castor oil, the unsaturated bond in the skeleton increases due to the dehydration reaction of the hydroxyl group provided in the fatty acid. This increase in unsaturated bonds and the triglyceride skeleton contained in the molecule enhance the affinity of dehydrated castor oil with diene-based rubber and aroma oil (mineral oil). As a result, vulcanized rubber in rubber composition, even when used in combination with aroma oil, has improved rolling resistance when used for airborne tire applications.

### DETAILED DESCRIPTION OF THE PREFERRED EMBODIMENTS

The rubber composition according to the present invention contains diene-based rubber, an aroma oil and a dehydrated castor oil.

Examples of the diene-based rubber include styrene butadiene rubber such as emulsion-polymerized polystyrene butadiene rubber (hereinafter, also referred to as “E-SBR”) and solution-polymerized polystyrene butadiene rubber (hereinafter, also referred to as “S-SBR”) obtained by an emulsion polymerization method (radical polymerization method) in water, natural rubber, isoprene rubber, and butadiene rubber.

The dehydrated castor oil contains triglycerides in which ricinoleic acid which are fatty acids and glycerin are ester-linked, as a main component. In the rubber composition according to the present invention, when the total amount of the diene-based rubber is 100 parts by mass, the content of the dehydrated castor oil is preferably set to 1 to 15 parts by mass.

The rubber composition according to the present invention contains an aroma oil as a plasticizer. However, it is preferable that the blending amount is as small as possible from the viewpoint of SDGs, and specifically, when the total amount of the diene-based rubber is 100 parts by mass, the blending amount of the aroma oil is preferably set to 5 to 30 parts by mass, more preferably set to 5 to 20 parts by mass.

The rubber composition according to the present invention contains a diene-based rubber, an aroma oil and a dehydrated castor oil. In the rubber composition, 0.1≤X/Y≤10 is established when the blending amount of the aroma oil is X and the blending amount of the dehydrated castor oil is Y. By designing a mixture of aroma oil and dehydrated castor oil within the range, the vulcanized rubber of the rubber composition improves rolling resistance when used for pneumatic tire applications. From the viewpoint of improving rolling resistance, the ratio of aroma oil to dehydrated castor oil is preferably set to 0.5≤X/Y≤9, more preferably set to 0.5≤X/Y≤5.

The rubber composition according to the present invention preferably contains, along with aroma oil and dehydrated castor oil, silica as a filler. Examples of the silica to be used include silicas usually used for rubber reinforcement, such as wet silica, dry silica, sol-gel silica, and surface-treated silica. Among these, wet silica is preferred. The content of the silica is preferably 1 to 150 parts by mass of the rubber component in the rubber composition.

When silica is contained as a filler, a silane coupling agent is also preferably contained together. The silane coupling agent is not limited as long as sulfur is contained in the molecule thereof, and various silane coupling agents to be added to rubber compositions together with silica may be used. Examples of such silane coupling agents include: sulfidesilanes such as bis(3-triethoxysilylpropyl) tetrasulfide (e.g., “Si69” manufactured by Degussa), bis(3-triethoxysilylpropyl) disulfide (e.g., “Si75” manufactured by Degussa), bis(2-triethoxysilylethyl)tetrasulfide, bis(4-triethoxysilylbutyl)disulfide, bis(3-trimethoxysilylpropyl) tetrasulfide, and bis(2-trimethoxysilylethyl)disulfide; mercaptosilanes such as γ-mercaptopropyltrimethoxysilane, γ-mercaptopropyltriethoxysilane, mercaptopropylmethyldimethoxysilane, mercaptopropyldimethylmethoxysilane, and mercaptoethyltriethoxysilane; and protected mercaptosilanes such as 3-octanoylthio-1-propyltriethoxysilane and 3-propionylthiopropyltrimethoxysilane. In the rubber composition, when the total amount of silica is set to 100% by mass, the content of the silane coupling agent is preferably 1 to 20% by mass.

The rubber composition according to the present invention may contain, as a filler, carbon black. Examples of the carbon black that can be used include: carbon blacks usually used in the rubber industry, such as SAF, ISAF, HAF, FEF, and GPF; and conductive carbon blacks such as acetylene black and ketjen black. The content of carbon black to be blended in the rubber composition preferably 1 to 60 parts by mass of the diene-based rubber in the rubber composition.

The rubber composition according to the present invention may contain, in addition to the diene-based rubber, aroma oil, dehydrated castor oil, silica and further carbon black, silane coupling agent, vulcanizing agent, a vulcanization accelerator, an antiaging agent, stearic acid, a softener such as wax or oil, a processing aid, etc.

As the antiaging agent, antiaging agents usually used for rubber, such as an aromatic amine-based antiaging agent, an amine-ketone-based antiaging agent, a monophenol-based antiaging agent, a bisphenol-based antiaging agent, a polyphenol-based antiaging agent, a dithiocarbamic acid salt-based antiaging agent, and a thiourea-based antiaging agent can be used. These may be used singly or in an appropriate combination. The content of the antiaging agent to be blended in the rubber composition preferably 1 to 5 parts by mass of the diene-based rubber in the rubber composition.

Examples of the vulcanization-based compounding agent include a vulcanizing agent such as sulfur and an organic peroxide, a vulcanization accelerator, a vulcanization accelerating aid, and a vulcanization retarder.

Sulfur as a vulcanizing blend may be conventional rubber sulfur. For example, powdered sulfur, precipitated sulfur, insoluble sulfur, or highly dispersible sulfur can be used. When the rubber physical properties and durability after vulcanization are taken into consideration, the amount of sulfur blended is preferably from 0.1 to 5 parts by mass, more preferably from 0.5 to 3.5 parts by mass, in terms of sulfur content, when the total amount of the diene-based rubber is taken as 100 parts by mass.

Examples of the vulcanization accelerator include vulcanization accelerators usually used for rubber vulcanization, such as a sulfenamide-based vulcanization accelerator, a thiuram-based vulcanization accelerator, a thiazole-based vulcanization accelerator, a thiourea-based vulcanization accelerator, a guanidine-based vulcanization accelerator, and a dithiocarbamic acid salt-based vulcanization accelerator, and these may be used singly or in an appropriate combination. The amount of vulcanization accelerator is preferably from 0.5 to 6 parts by mass when the total amount of the diene-based rubber is taken as 100 parts by mass.

The rubber composition according to the present invention is obtained by kneading the diene-based rubber, aroma oil, the dehydrated castor oil, silica and further carbon black, silane coupling agent, the vulcanizing agent, the vulcanization accelerator, the antiaging agent, stearic acid, the softener such as wax or oil, the processing aid, etc. with the use of a kneading machine usually used in the rubber industry, such as a Banbury mixer, a kneader, or a roll.

A method for blending the above components is not limited, and any one of the following methods may be used: a method in which components to be blended other than vulcanization-type compounding agents such as a vulcanizing agent and a vulcanization accelerator are previously kneaded to prepare a master batch, the remaining components are added to the master batch, and the resultant is further kneaded, a method in which components are added in any order and kneaded, and a method in which all the components are added at the same time and kneaded.

Since the rubber composition according to the present invention uses dehydrated castor oil which is an oil derived from a plant, it is environmentally friendly. Therefore, it is particularly suitable as a rubber composition for use in a pneumatic tire application in which a demand for reducing aroma oil, which is a petroleum-derived resource, has been particularly increased in recent years toward social construction conscious of SDGs. In addition, vulcanized rubber of the present invention rubber composition is favorable in terms of SDGs due to improved low fuel consumption due to its superior rolling resistance.

### EXAMPLES

Hereinbelow, the configuration and effect of the present invention will be described with reference to specific examples etc. Incidentally, evaluation items in Examples and the like, each rubber composition was heated at 160° C. for 20 minutes, the rubber sample obtained by vulcanization was evaluated based on the following evaluation conditions.

### (Rolling Resistance of Vulcanized Rubber in Rubber Composition)

The viscoelastic testing machine manufactured by Toyo Seiki Co., Ltd. was used to measure the frequency 10 Hz, static strain 10%, dynamic strain 1%, loss factor tan δ at 60° C. The evaluation was displayed as an index with the value of comparison case 1 set at 100. The larger the value, the better the rolling resistance of vulcanized rubber.

### (Preparation of Rubber Composition)

According to the formulation of Table 1, the rubber compositions of Example 1-4 and Comparative Example 1 were blended and kneaded using an ordinary Banbury mixer to adjust the rubber composition. Each of the blending agents described in the table is shown below (in Table 1, the blending amount of each blending agent is shown in parts by mass based on 100 parts by mass of the rubber component)
SBR1 (ESBR (emulsion-polymerization SBR): trade name SBR1502 (manufactured by ENEOS Material)
SBR2 (SSBR (solution-polymerization SBR): trade name “HPR350” (manufactured by ENEOS Material Co., Ltd.)
Carbon black (CB) (HAF): trade name “N339 Seast KH” (manufactured by Tokai Carbon Co., Ltd.)
Silica: trade name “Nipshire AQ” (Tosoh Co.,)
Silane coupling agent: trade name Si69 (Degusa Co., Ltd.)
Aroma Oil: trade name Process NC140 (ENEOS Co., Ltd.)
Dehydrated castor oil: DCO (Ito Oil Co., Ltd.)
Stearic Acid: trade name Lunac S-20 (Kao Co., Ltd.)
Zinc Oxide: trade name Zinc Oxide 2 (Mitsui Metal Mineral Co., Ltd.)
Wax: trade name “OZOACE0355” (manufactured by Nippon Seiyu Co., Ltd.)
Anti-aging agent 1: trade name “Nocrac 6C” (manufactured by Dainippon Shinko Chemical Industry Co., Ltd.)
Anti-aging agent 2: trade name “ANTAGE RD” (Kawaguchi Chemical Co., Ltd.)
Vulcanization accelerator 1: trade name “Soxinol CZ” (manufactured by Sumitomo Chemical Co., Ltd.)
Vulcanization accelerator 2: trade name “NOXERA D” (made by Ouchi New Chemicals)
Sulfur: trade name “Powdered Sulfur” (Tsurumi Chemical Co., Ltd.)

TABLE 1

| Comparative | Exam- | Exam- | Exam- | Exam- |
|---|---|---|---|---|
| Example | ple | ple | ple | ple |
| 1 | 1 | 2 | 3 | 4 |

(Formulation)

| | | | | | |
|---|---|---|---|---|---|
| SBR1 | 40 | 40 | 40 | 40 | 40 |
| SBR2 | 60 | 60 | 60 | 60 | 60 |
| Carbon black | 5 | 5 | 5 | 5 | 5 |
| Silica | 85 | 85 | 85 | 85 | 85 |
| Silane coupling | 7 | 7 | 7 | 7 | 7 |
| agent | | | | | |
| Aroma oil | 27 | 24.3 | 21.6 | 18.9 | 13.5 |
| Dehydrated castor | | 2.7 | 5.4 | 8.1 | 13.5 |
| oil | | | | | |
| Stearic Acid | 2 | 2 | 2 | 2 | 2 |
| Zinc Oxide | 2 | 2 | 2 | 2 | 2 |
| Wax | 2 | 2 | 2 | 2 | 2 |
| Anti-aging agent 1 | 2 | 2 | 2 | 2 | 2 |
| Anti-aging agent 2 | 1 | 1 | 1 | 1 | 1 |
| Vulcanization | 2 | 2 | 2 | 2 | 2 |
| accelerator 1 | | | | | |
| Vulcanization | 2 | 2 | 2 | 2 | 2 |
| accelerator 2 | | | | | |
| Sulfur | 2 | 2 | 2 | 2 | 2 |

(Evaluation)

| | | | | | |
|---|---|---|---|---|---|
| Rolling resistance | 100 | 101 | 102 | 105 | 106 |

In Comparative Example 1, only an aroma oil was blended in the rubber composition. In Examples 1 to 4, when the blending ratio of aroma oil and dehydrated castor oil was varied and blended in the rubber composition, the rolling resistance was remarkably improved in the vulcanized rubber.

What is claimed is:

1. A rubber composition comprising a diene-based rubber, an aroma oil and a dehydrated castor oil, wherein 0.1≤X/Y≤10 is established when the blending amount of the aroma oil is X and the blending amount of the dehydrated castor oil is Y.

2. The rubber composition according to claim 1, wherein the content of the dehydrated castor oil is 1 to 20 parts by mass when the total amount of the diene-based rubber is 100 parts by mass.

3. The rubber composition according to claim 1, wherein the content of the aroma oil is 5 to 40 parts by mass when the total amount of the diene-based rubber is 100 parts by mass.

4. The rubber composition according to claim 1, further comprising silica.

5. A pneumatic tire comprising a vulcanized rubber of the rubber composition according to claim 1.
